(19) United States
(12) Patent Application Publication
(10) Pub. No.: US 2007/0012849 A1
(43) Pub. Date: Jan. 18, 2007

(54) Under-cabinet reading aid

(76) Inventor: Gary J. Brady, Countryside, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/182,042

(22) Filed: Jul. 14, 2005

(51) Int. Cl. G05B 15/00

(52) U.S. Cl. 248/453; 700/264

(57) ABSTRACT

A reading aid for mounting to the underside of a horizontal surface, such as a cabinet or a shelf, includes a mounting member, an optical magnification device, an illumination source, a switch and a power source. The mounting member is mounted to the underside of the horizontal surface and the optical magnification device is pivotally attached to the mounting member. The optical magnification device is moveable between a storage position and an operative position. The illumination source, the power source and the switch are connected in circuit for illuminating any reading material situated beneath the reading aid.

### BACKGROUND OF THE INVENTION

This invention generally relates to reading aids which magnify images and printed material, and more particularly to a reading aid for mounting beneath a cabinet to magnify and illuminate reading material placed on a countertop below the cabinet.

As most people age, their vision begins to deteriorate, which affects their ability to read. When this happens, people usually turn to reading aids to help them read. One of the most common reading aids is a set of reading glasses, providing a mild magnification. An alternative is a handheld magnification device. Although handheld magnification devices are suitable in most instances, there are situations in which a handheld device is impractical and inconvenient. One such situation is when a person is reading and following a recipe from a cookbook while preparing a meal.

While cooking, a person's hands are occupied with preparing the meal, which makes it difficult to both cook and hold onto a magnification device. Furthermore, it is inconvenient and frustrating to have to stop preparing the meal and pick up a magnifying device every time one wishes to read from the cookbook. This also presents health issues, since foodstuffs could remain on the magnifying device handle, germs can accumulate and ultimately the food can become infected.

Accordingly, there remains a need for a reading aid which allows a person to see a magnified object without having to use hands to support the device.

### SUMMARY OF THE INVENTION

The present invention generally relates to a reading aid mountable to an underside of a horizontal surface, such as a cabinet or shelf. The reading aid facilitates the reading of material below the cabinet, e.g., on a countertop below the cabinet. An embodiment of the present invention comprises a mounting member, an optical magnification device such as a Fresnel lens, and an illumination source.

The mounting member is mounted to the underside of a horizontal surface and the optical magnification device is pivotally connected to the mounting member. According to a preferred embodiment, the mounting member includes a rotatable body member which supports the optical magnification device, so that by rotating the body member the optical magnification device can be pivoted or moved between a storage position and an operative position.

The magnification device can be mounted in other ways, and need not be accompanied by an illumination device. For example, in a second preferred embodiment, the magnification device is associated with a mounting member having an opposed pair of side rails. Each side rail includes a guide channel or groove. The optical magnification device includes guide projections which engage the guide channel. This allows the optical magnification device to be slidably connected to the mounting bracket. Additionally, the guide channels include a pivot space which allows the guide projections to rotate in the channel and the optical magnification device to pivot into an operative position.

Preferably, in both embodiments, an illumination source can be associated with the mounting member to illuminate a region below the reading aid. The illumination source may be connected in circuit with a power source and a switch. Optionally, the switch may be a position-sensing switch which activates the illumination source when the optical magnifying device is moved into the operative position.

It is accordingly a general aspect or object of the present invention to provide an under-cabinet reading aid that can be mounted to the underside of a horizontal surface.

Another aspect or object of the present invention is to provide an under-cabinet reading aid which conserves space and is conveniently stored when not in use.

Another aspect or object of the present invention is to provide an under-cabinet reading aid which illuminates a magnified object when the optical magnifying device is in the operative position.

Other aspects, objects and advantages of the present invention will be understood from the following description according to the preferred embodiments of the present invention, specifically including stated and unstated combinations of the various features which are described herein, relevant information concerning which is shown in the accompanying drawings.

### BRIEF DESCRIPTION OF THE DRAWINGS

In describing the preferred embodiments of the present invention, reference will be made to the accompanying drawings, wherein:

FIG. 1 is a perspective view of a preferred embodiment of an under-cabinet reading aid according to aspects of the present invention, attached to the bottom wall of a cabinet and in the operative position;

FIG. 2 is an exploded view of the mounting members and the body member of the under-cabinet reading aid shown in FIG. 1;

FIG. 3 is a cross-sectional, representative view of the body member and mounting members of the under-cabinet reading aid shown in FIG. 1;

FIG. 4 is an end view of the under-cabinet reading aid shown in FIG. 1, in the storage position;

FIG. 5 is a sketch of a person using the under-cabinet reading aid shown in FIG. 1, in the operative position;

FIG. 6 is a perspective view of another embodiment of an under-cabinet reading aid according to aspects of the present invention, in the storage position;

FIG. 6A is a perspective view of one of the side rails of the under-cabinet reading aid shown in FIG. 6;

FIG. 7 is a plan view of the mounting member of the under cabinet reading aid shown in FIG. 6;

FIG. 8 is a plan view of the optical magnification device of the under-cabinet reading aid shown in FIG. 6; and

FIG. 9 is a cross-sectional side view of the under-cabinet reading aid shown in FIG. 6.

### DESCRIPTION OF THE PREFERRED EMBODIMENTS

While detailed embodiments of the present invention are disclosed herein, it is to be understood that the disclosed embodiments are merely exemplary of the invention, which may be embodied in various further forms. Therefore, specific details disclosed herein are not to be interpreted as limiting, but merely as a basis for the claims and as a representative basis for teaching one skilled in the art to variously employ the present invention in any appropriate manner.

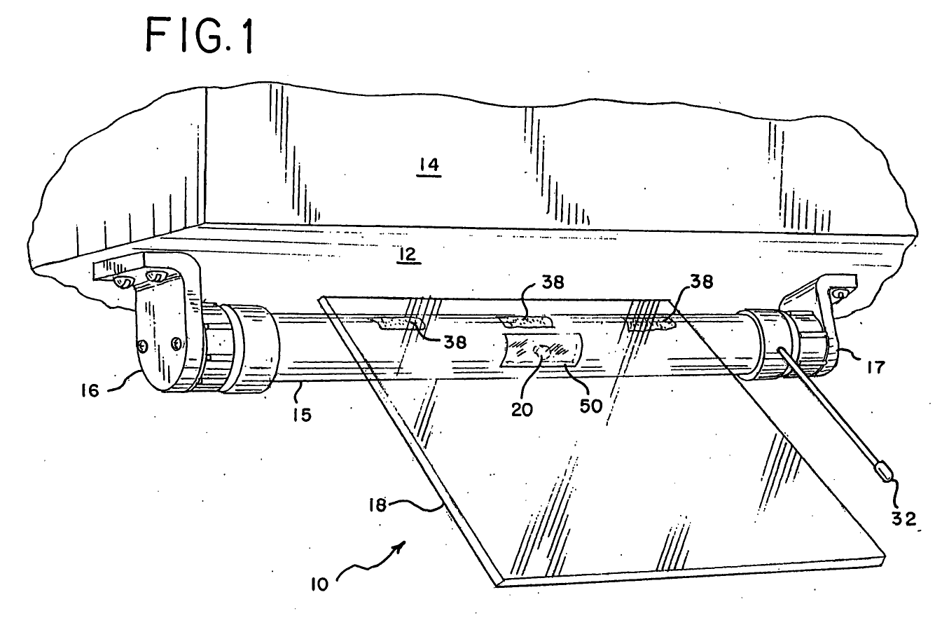

Referring now to the drawings and more particularly to FIG. 1, in a preferred embodiment, a reading aid 10 is mounted to a bottom wall 12 of a cabinet 14. The reading aid 10 may include a body member 15, mounting members 16 and 17, an optical magnification device 18, and an illumination source 20.

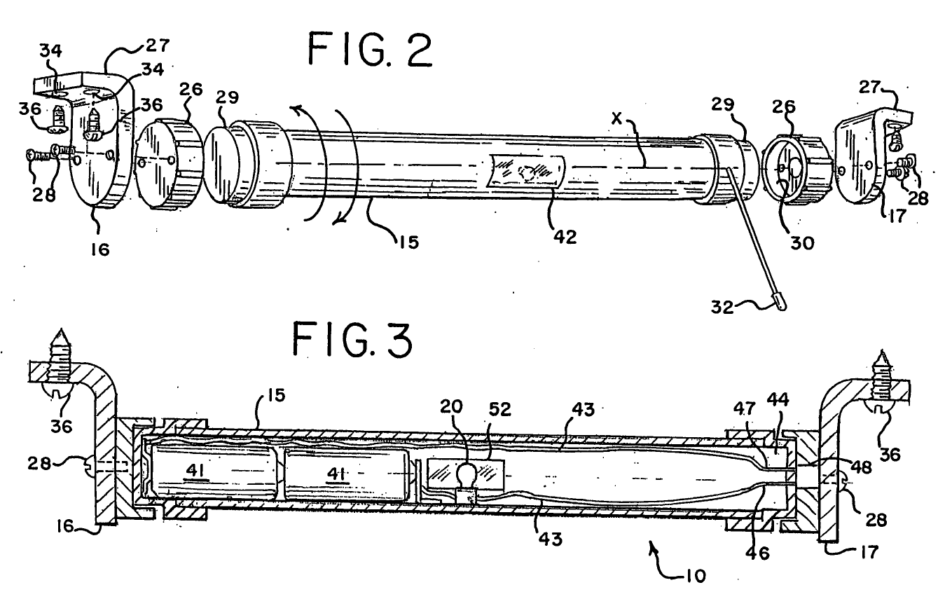

The mounting members 16, 17 are coupled to and support member 15. As particularly shown in FIG. 2, illustratively, each mounting member 16, 17 is preferably generally in the form of an (inverted) L-shaped bracket. Each mounting member 16, 17 may include a connecting member 26 for forming a couple with the body member 15 and a mounting portion 27 for securing the mounting member to the bottom wall 12 of cabinet 14. Each connecting member 26 is attached to its respective mounting member 16 or 17 by screws 28. In the alternative, the connecting members 26 may be integrally formed with their respective mounting member 16 or 17.

The body member 15 preferably comprises a generally cylindrically elongated shape wherein each end of the body member 15 may be rotatably coupled to the respective connecting member 26. Preferably, the rotatable couple is a journal-bearing connection wherein each end of the body member 15 includes a journal 29 which may be inserted into a corresponding bearing 30 located in each connecting member 26. This journal-bearing connection allows the body member 15 to rotate in both a clockwise and counter-clockwise direction about its axial axis X. Although this embodiment uses journal-bearing connections to couple the body member 15 to the mounting members 16 and 17, any suitable rotatable coupling known in the art may be used, such as a hinge that allows the body member to pivot about the hinge. In addition, a handle 32 may be connected to the body member 15 to allow a user to rotate the body via the handle.

To affix the mounting members 16, 17 to the bottom wall 12 of the cabinet 14, preferably, each mounting portion 27 includes a pair of apertures 34 which receive mounting fasteners, such as, bolts or screws 36. The mounting bolts or screws 36 are inserted through apertures 34 and fastened to the bottom wall 12 of cabinet 14. However, any conventional fashion of fastening mounting portion 27 to the bottom wall 12 may be used.

Referring back to FIG. 1, the body member 15 supports the optical magnification device 18 so that the optical magnification device 18 pivots or moves from a storage position to an operative position when the body member 15 is rotated. The optical magnification device 18 is preferably attached to the body member 15 by an adhesive 38, but it may also be attached to the body member 15 by any other conventional method. The optical magnification device 18 may be a thin flat generally rectangular planar magnification lens, such as a Fresnel lens, but it may also be any other type of device which optically magnifies an object.

As seen in FIG. 3, the body member 15 may be generally hollow and have an illumination source 20, such as a light bulb or (one or more) light emitting diodes, disposed within the body member 15. To supply power to the illumination source, a power supply 41, such as one or more batteries, also may be disposed within the body member 15. The power supply 41 is connected to the illumination source 20 by wires 43. Optionally, the reading aid 10 also may include a switch 44 which is in circuit with illumination source 20 and batteries 41 by wires 43. Illustratively, switch 44 may comprise a pair of spaced apart contacts 46 and 47, which protrude from one end of the body member 15, and a contact strip 48, which is located on the mounting member 17. When the body member 15 is rotated to move the magnification device 18 into the operative position, contacts 46, 47 will engage the contact strip 48, completing the circuit and activating the illumination source 20. When the body member 15 is rotated to move the magnification device 18 into the storage position, contacts 46, 47 will disengage the contact strip 48, breaking the circuit and deactivating the illumination source.

When activated, the illumination source 20 illuminates an area to be magnified under the reading aid 10 through an opening 50 in the body member 15, as shown in FIG. 1. Additionally, a reflector 52 may be positioned behind the illumination source 20 to direct the light toward the area to be magnified.

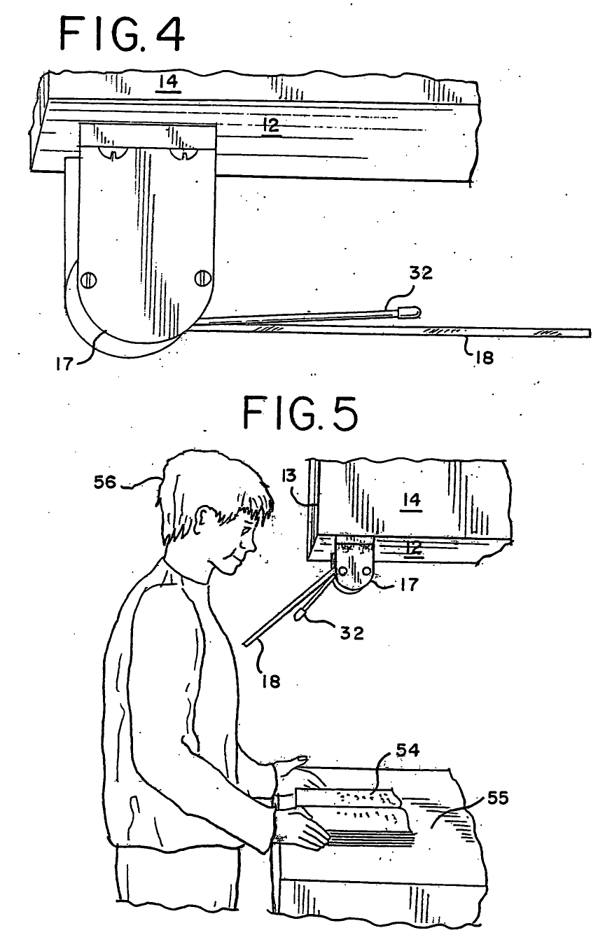

In operation, the reading aid 10 may start with the optical magnification device 18 in the storage position, as shown in FIG. 4. In the storage position, the magnification device 18 is located directly beneath and preferably generally parallel to the bottom wall 12 of the cabinet 14. (This is to conserve space.) To use the reading aid 10, a user applies pressure to the handle 32 and rotates the body member 15 (clockwise in FIG. 4) to pivot the optical magnification device 18 from the storage position to the operative position shown in FIG. 5. In the operative position, the magnification device 18 protrudes out and away from the bottom wall 12 of the cabinet 14.

Additionally, as the body member 15 is rotated to move the magnification device 18 into the operative position, contacts 46 and 47 make contact with contact strip 48 automatically activating the illumination source 20. When activated, the illumination source 20 illuminates an object 54, which is located on a counter top 55 beneath the cabinet 14. A user 56 may then look through the optical magnification device 18 to view the magnified and illuminated object 54. The user 56 may also use the handle 32 to adjust the angle of the optical magnification device 18 as needed. It will be appreciated that one can place the reading aid 10 in the operative position before beginning to cook. Hence, manipulation of the handle 32 is not necessary during cooking, and the risk of transferring bacteria from a handle to the hands of the cook and then to the food is minimized, as the reading aid can stay in place, illuminating the cookbook or recipe, throughout the cooking process (or as long as needed).

When the user is finished using the reading-aid, the user may simply move the optical magnification device 18 back to the storage position (as shown in FIG. 4) by rotating the body member 15 (counter-clockwise in FIG. 5) via handle 32. When the body member is rotated, contacts 46 and 47 will disengage contact strip 48, automatically deactivating illumination source 20.

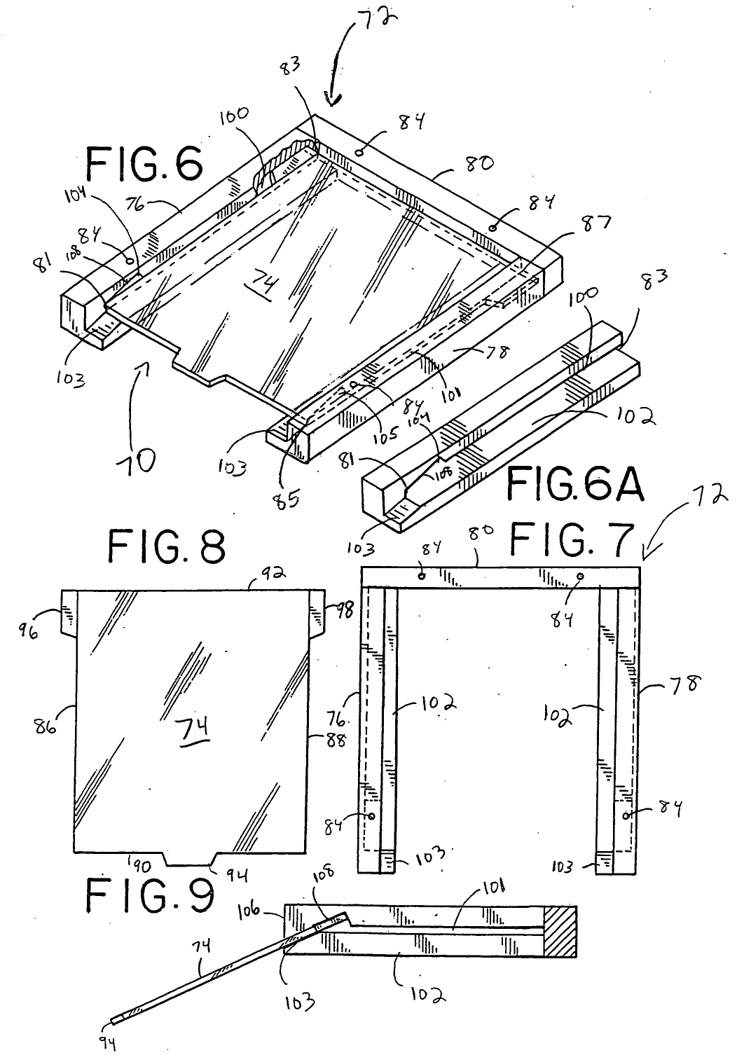

FIG. 6 illustrates a second preferred embodiment of an under-cabinet reading aid 70 of the present invention. The reading aid 70 includes a mounting member 72 and an optical magnification device 74. As shown in FIG. 7, illustratively, the mounting member 72 comprises a generally U-shaped configuration including a pair of opposing side rails 76, 78 connected by a rear rail 80. The mounting member 72 also includes apertures 84 for receiving fastening members for mounting the under-cabinet reading aid 70 to the underside of a horizontal surface, such as the bottom wall of a cabinet. It is contemplated that the rear rail 80 may be eliminated from mounting member 72 and that the mounting member may just include the side rails 76, 78.

As illustrated in FIG. 8, the optical magnification device 74 is preferably a thin flat generally rectangular planar magnification lens, such as a Fresnel lens. The magnification device 74 includes opposing side edges 86, 88, a front edge 90 and a rear edge 92. A gripping portion 94, for gripping and moving the optical magnification device 74, may extend from the center of the front edge 90 of the optical magnification device. Side edge 86 of the optical magnification device includes a guide member 96 extending from the side edge 86, preferably, at a location proximal the rear edge 92. Likewise, side edge 88 also includes a guide member 98 which extends from side edge 88 at a location proximal rear edge 92.

In the illustrated embodiment, the optical magnification device 74, the guide members 96, 98 and the gripping portion 94 are a single structure. However, it is understood that the guide members and the gripping portion may be separate structures which may be attached to the optical magnification device in any suitable manner.

As shown in FIGS. 6 and 6A, side rail 76 includes a generally horizontal guide channel 100 which extends substantially along the length of the side rail. The guide channel 100 has a distal end 83 near the rear rail 80 and a closed proximal end 81 opposite the distal end. Side rail 78 also includes a similarly configured guide channel 101, as shown in phantom in FIG. 6, having a closed proximal end 85 and a distal end 87. The guide channels 100, 101 are designed to receive guide members 96, 98 of the optical magnification device 74. The guide members 96, 98 move between the proximal and distal ends of the guide channels 100, 101, allowing the optical magnification device to be slidably connected to the mounting member, i.e., the optical magnification device may move back and forth relative to the mounting member by sliding the optical magnification device within the guide channels. Additionally, rear rail 80 may also include a channel (not shown) which is generally aligned with the guide channels 100, 101 and may be adapted to receive the rear edge 92 of magnification device 74.

Each side rail 76, 78 also includes a first optical magnification device support surface 102 and a second support surface 103 both of which extend inwardly from the bottom of the respective side rail. The first support surfaces 102 support the optical magnification device while it is in the storage position and as the magnification device is moved from the storage to the operative position. The second support surfaces 103 extend at a downward angle to support the optical magnification device 74 when it is in the operative position, as illustrated in FIG. 9.

Prior to assembly, side rails 76, 78 and rear rail 80 of mounting member 72 may be separate components. Reading aid 70 may be assembled by inserting the guide members 96, 98 of the magnification device 74 into guide channels 100, 101 before attaching the side rails 76, 78 to the rear rail 80.

As illustrated in FIGS. 6, 6A and 9, each of the guide channels 100, 101 includes a pivot space 104, 105, respectively, located at or near the proximal end of each of the guide channels. Illustratively, pivot spaces 104, 105 are triangular shaped spaces located along the top of their respective guide channel adjacent the proximal end of the channel. When the guide members 96, 98 are generally aligned with pivot spaces 104, 105, the pivot spaces provide a space which allows the guide members to rotate within the guide channel. This arrangement results in being able to pivot the optical magnification device 74 into the operative position, as shown in FIG. 9. The pivot spaces also aid in retaining the optical magnification device in the operative position.

In operation, the under-cabinet reading aid 70 may start with the optical magnification device 74 in the storage position, as seen in FIG. 6. In the storage position, the optical magnification device 74 is stored within the mounting member 72. A user may place an object, such as a cook book, on a counter beneath the under-cabinet reading aid 70. From the storage position, the user may grip the optical magnification device 74 by the gripping portion 94, and pull the gripping potion so that guide members 96, 98 move forward in the guide channels and the optical magnification device slides forward with respect to the mounting member 72. As the optical magnification device 74 slides forward, it gradually extends out of the front 106 of the mounting member 72. The optical magnification device 74 slides forward until the guide members 96, 98 contact the closed proximal ends 81, 85 of guide channels 100, 101. In this position, the guide members 96, 98 are generally aligned with the respective pivot space 104, 105. The optical magnification device 74 may now be moved into the operative position by moving front edge 90 of the magnification device in a downward direction thereby rotating the guide members 96, 98 in the pivot spaces 104, 105. In the operative position, as illustrated in FIG. 9, a portion of edges 86, 88 contact and are supported by second support surfaces 103 and the front surface of the guide members 96, 98 contact surface 108 of the pivot space.

When the user is finished with using the reading aid, the user may pivot the optical magnification device out of the operative position and slide the optical magnification device back into the mounting member.

It will be understood that an illumination device could also be employed with device 70 and that one could adapt device 10 and 70 to use household current, using a typical transformer to step down the voltage, and electrical wires as needed.

It will also be appreciated that an illumination device could be mounted non-rotatably on the cabinet underside, but still in position to illuminate a cookbook or recipe placed on the counter beneath the cabinet. Preferably the illumination device is in circuit with a position-sensing switch, as described herein.

It will also be understood that devices 10 and 70 could be mounted to the underside of any horizontal surface where one desires to magnify and illuminate an object beneath the surface. Such surfaces may include shelving above tool benches and craft tables.

It will be understood that the embodiments of the present invention which have been described are illustrative of some of the applications of the principles of the present invention. Numerous modifications may be made by those skilled in the art without departing from the true spirit and scope of the invention, including those combinations of features that are individually disclosed or claimed herein.

What is claimed:

1. A reading aid comprising:
a mounting member adapted to be mounted to the underside of a horizontal surface;
an optical magnification device pivotally connected to the mounting member, said optical magnification device movable between a storage position and an operative position; and
a source of illumination for illuminating a region below the reading aid.

2. The reading aid according to claim 1 wherein the storage position comprises a position wherein the optical magnification device is located under and generally parallel to the horizontal surface and the operative position comprises a position wherein the optical magnification device projects away from the horizontal surface.

3. The reading aid according to claim 1 further including a rotatable body member for pivotally connecting the optical magnification device to the mounting member.

4. The reading aid according to claim 3 wherein the body member comprises a generally cylindrical elongated shape.

5. The reading aid according to clam 3 further comprising a handle attached to the body member to rotate the body member when pressure is applied to the handle.

6. The reading aid according to claim 1 wherein the optical magnification device is slidably movable relative to the mounting member.

7. The reading aid according to claim 6 wherein the mounting member comprises a pair of opposed side rails each having a guide channel and the optical magnification device further includes a portion that mates with at least one of said side guide channels.

8. The reading aid according to claim 7 wherein the portion of the optical magnification device comprises a guide member.

9. The reading aid according to claim 7 wherein each of the guide channels include a pivot space for allowing the optical magnification device to pivot.

10. The reading aid according to claim 1 wherein the optical magnification device comprises a generally rectangular planar magnifying lens.

11. The reading aid according to claim 1 further comprising a power source and a switch connected in circuit with the illumination source.

12. The reading aid according to claim 11 wherein the switch is a position-sensing switch that activates the illumination source when the optical magnification device is moved into the operative position.

13. A reading aid comprising:
an elongated body member;
an optical magnification device affixed to the body member and rotatable therewith between a storage position and an operative position;
a source of illumination, a power source, and a switch associated with the body member and connected in circuit for illuminating a region below the reading aid; and
a mounting member for connecting said body member to an underside of a horizontal surface, wherein said body member is rotatably connected whereby when said optical magnification device is moved into the operative position, said source of illumination illuminates any reading material situated beneath the horizontal surface to which the reading aid is mounted.

14. A reading aid according to claim 13 further comprising a second mounting member, and the elongated body member including opposite ends wherein each of the mounting members is coupled to a respective one of the ends of the elongated body member.

15. A reading aid according to claim 13 wherein the optical magnification device is a generally rectangular planar magnifying lens.

16. The reading aid according to claim 13 wherein the storage position comprises a position wherein the optical magnification device is located under and generally parallel to the underside of the horizontal surface, and the operative position comprises a position wherein the optical magnification device projects away from the underside of the horizontal surface.

17. The reading aid according to claim 13 wherein the power source comprises a battery and the illumination source and the battery are disposed within the elongated body.

18. A reading aid comprising:
an optical magnification device; and
a mounting member adapted for mounting on an underside of a horizontal surface, said optical magnification device being connected to the mounting member in a slidable configuration.

19. The reading aid of claim 18 wherein the mounting member comprises a pair of opposed side rails, each of said side rails including a guide channel; and
said optical magnification device further including guide members which engage said guide channels.

20. The reading aid of claim 19 wherein each of the guide channels include a pivot space for allowing the optical magnification device to pivot.

21. The reading aid of claim 18 further including an illumination source associated with the mounting member.

22. A method for magnifying and illuminating an object below a cabinet comprising:
attaching a reading aid to an exterior bottom wall of the cabinet, the reading aid comprising an optical magnification device and an illumination source for illuminating an object to be magnified, said optical magnification device being movable between a storage position and operative position;
moving the optical magnification device from the storage position to the operative position;
activating the illumination source; and
viewing the object through the optical magnification device.

23. The method according to claim 22 wherein the storage position comprises a position wherein the optical magnification device is located under and generally parallel to the exterior bottom wall of the cabinet, and the operative position comprises a position wherein the optical magnification device projects away from the exterior bottom wall of the cabinet.

24. The method according to claim 22 including automatically activating the illumination source in response to moving the optical magnification device into the position for use.
